(19) United States
(12) Patent Application Publication
(10) Pub. No.: US 2026/0029016 A1
(43) Pub. Date: Jan. 29, 2026

(54) LEAK-RESISTANT CLINCH FASTENER

(71) Applicant: Ian Burke, Galway (IE)

(72) Inventor: Ian Burke, Galway (IE)

(21) Appl. No.: 19/275,163

(22) Filed: Jul. 21, 2025

Related U.S. Application Data
(60) Provisional application No. 63/675,336, filed on Jul. 25, 2024.

(51) Int. Cl. F16B 37/06; F16B 39/282

(52) U.S. Cl. CPC F16B 37/068; F16B 39/282

(57) ABSTRACT

A clinch fastener has material displacing features which create a lengthened leak path boundary between the fastener and an attached panel which can be a potential leak path of fluid from one side of the panel to the other. The material displacing features include a dimpled peripheral rim which displaces material of the attached panel along the perimeter of the fastener and lengthens the leak path. An increased installation pressing speed using these structures creates trapped compressed pockets of air above atmospheric pressure between the fastener and the panel providing additional leak resistance.

### RELATED APPLICATIONS

This is a regular patent application related to U.S. Provisional Application No. 63/675,336 entitled, “Leak Resistant Clinch Fastener” filed on Jul. 25, 2024 priority from which is hereby claimed.

### FIELD OF THE INVENTION

The present invention relates to mechanical fasteners and particularly to clinch type fasteners which deform an attached object to achieve its connection. More specifically, it relates to a clinch fastener which resists fluid leakage between itself and the clinched-in object.

### BACKGROUND OF THE INVENTION

The use of clinch-based fasteners in industrial design has undoubtedly become popular owing to their convenient and dependable application during the assembly process. They can be installed and then tightened up with nuts or bolts further along the production line. This is unlike nuts and bolts used together which must be tightened immediately or the bolts will be dislodged from the holes. Furthermore, clinch fasteners, unlike regular bolts, do not need to be held on both sides when tightening.

They can also be utilized in applications where accessing the fastener head side of the material is not viable. Clinch fasteners are much easier and more efficient to install compared to bolts. Current self-clinching fastening products are installed into punched, drilled or reamed holes, allowing a secondary component to attach to the fastener to combine two components mechanically. To achieve this, the process of material displacement and material deformation is used to create the mechanical performance of the fastener. Existing self-clinching fasteners include radial knurls, radial ribs and radial serrated clinching rings. Usually, the fastener is a more rigid material than the material it is being installed into, and these features allow the cold flow of material into recesses and grooves and other features of the self-clinching fastener to secure it into the preferred material. Typical self-clinching fasteners use special dies to force the material into these recesses and grooves. Once the fastener is installed, it is a permanent fixture and removal results in material failure or part failure.

Existing self-clinching fasteners have good torque-out (rotational), push-out and pull-through resistance. Push-out testing is where the fastener is put under a load against the direction of the installation to try and force the material out of the recesses of the fastener. Pull-through testing is trying to pull the fastener through the material it is installed in. These performance requirements can differ between applications, and fasteners can be adapted to possess better torque-out or pull-through. The trade-off becomes complicated when ingress protection is considered a performance requirement.

Many applications require high torque-out requirements and the fastener being water-tight capable. However, this isn't easy to achieve. Ingress protection refers to the level of protection offered by a device to protect its components against solids and liquids. These levels of protection are denoted in standards such as IEC 60529 or ISO 20653. These levels of protection are determined by specific test requirements that the device under test must pass to be compliant with that level of protection.

In years past, there was primary importance on the mechanical performance of the fastener, and ingress protection being of secondary importance; however, as there is a switch to electrical applications where there wasn't before, there is a much greater emphasis on ingress protection and puts it on par with the mechanical performance in many applications. If devices were to be damaged due to water, results could be catastrophic, e.g., electric cars catching fire after flooding as when the water dries out, the soluble minerals are left behind and may spark and set the lithium battery pack on fire and lay waste to all the valuable technology.

Many factors affect liquid ingress protection, such as the fastener's material, the fastener being installed, and the hardness of the fastener and the panel material. The hole size in the fastener installed dramatically affects the functioning of the water-tight seal as there is less material to increase the path length to prevent ingress damage. One of the most significant factors affecting ingress protection in fasteners is the geometry of the fastener and its features. Good torque-out, push-out and pull-through are sometimes reasonable indications of good ingress protection. These are some of the many reasons why an invention such as this is needed in the self-clinching fastener industry. It is therefore an object of the invention to satisfy this need in the art.

For a clinch-based fastener to work satisfactorily it requires a hardness differential between it and the panel it is been installed into. A captive feature must be implemented into the fastener design for the deformed panel material to be locked into. After installation a radial segment of high material interaction and contact has now been generated. For an Ingress penetration event to take place, it now must be sufficiently small in size to transverse along the nonlinear highly deformed voids between these matting surfaces. The probability that one such void is of sufficient size to allow ingress penetration to commence is unlikely, but a method to decrease this chance has now been devised.

Where capillary action and adhesion are primary factors for liquid to transverse along a Boundary surface. When the length that the liquid has to travel is elongated or convoluted, penetration is resisted. For clinch-based fasteners to be ingress repellent, the most important design factors are material deformation plus a long leak path. The longer the path, the higher chance that any potential voids between the joined surfaces will be closed to a point where capillary action and adhesion will be overcome. In this case the surface tension of the liquid making the liquid stagnant in its approach or simply the void size is significantly small such that a water molecule cannot pass through.

There is therefore a need in the art of clinch fastening for a fastener and/or a fastening method which provides enhanced leak resistance.

### SUMMARY OF THE INVENTION

The fastener of the present invention dramatically decreases the chances of an ingress penetration by adding structural features which among other things lengthens the leak path. An additional peripheral displacer of the invention around the outside of the fastener lengthens the leak pathway and also produces a preventive design element. This addition of features to the head of self-clinching fasteners will elongate the length of the leak path to an extent that liquid won't travel along them. This creates a joint that does not need sealants, O-rings, or welds to create a watertight joint with the panel material

With this elongated and convoluted circuitous joint liquid cannot travel under the head of the fastener by capillary action, causing rusting and flaking of material, leading to the accelerated wear on the joint and the creation of new leak paths. This structural configuration together with an increased pressing speed creates pockets of encapsulated air along the fastener boundary. The encapsulated air, confined to its respective locations formed during the installation process will be pressurized to above atmospheric conditions. This creates an additional barrier for ingress to overcome. This also decreases the probability of voids being present in undesired locations.

More specifically, the applicant has devised a clinch fastener comprising a body having top and bottom ends with a cylindrical shank at the top and a displacer bead at the bottom end. A radial undercut is located immediately above the displacer bead. A displacer ring is located immediately above the undercut and extending radially from the undercut. A flange is located immediately above the displacer ring having a planar inner portion extending from the top of the displacer ring. A peripheral rim extends downward from the inner portion of the flange. A shank extends upwardly from the flange having a distal end defining the top end of the fastener. The rim has a circular edge adapted and constructed to penetrate and displace material of a receiving panel into which the fastener is pressed.

In some embodiments the edge of said rim is dimpled, having a series of hemi-spherical indentations. In others, first concave corner is located at a junction of the displacer ring and the inner flange and wherein a second concave corner is located at a junction of the inner flange and the rim. In some cases, a receiving panel is composed of metal the fastener body has an internally threaded through-bore. Alternately, the shank may be externally threaded.

In a method of affixing the above-described embodiments to a receiving panel of metal, a rapid pressing of the fastener into the panel with sufficient speed creates pockets of air above atmospheric pressure which are trapped and encapsulated at least at one of the first and second concave corners.

As further described below, and depicted in the following drawings, the present invention provides a leak resistant clinch fastener and installation method which surpasses the sealing properties of clinch fasteners known to the prior art. The following drawings will inform one of skill in the art of one embodiment of the invention.

### BRIEF DESCRIPTION OF THE DRAWINGS

FIG. 1 is a bottom-front isometric view of one embodiment of the invention.

FIG. 2 is a side elevation sectional view, top side up, of the fastener of FIG. 1 installed into a receiving panel.

FIG. 3 is a side elevation sectional view of an installed fastener of the prior art.

FIG. 4 is a side elevation sectional view.

FIG. 5 is a closeup view taken from FIG. 4 as shown in that figure depicting air pockets A and B created during installation.

FIG. 6 is a bottom isometric view of an alternate stud embodiment.

### DESCRIPTION OF THE PREFERRED EMBODIMENT

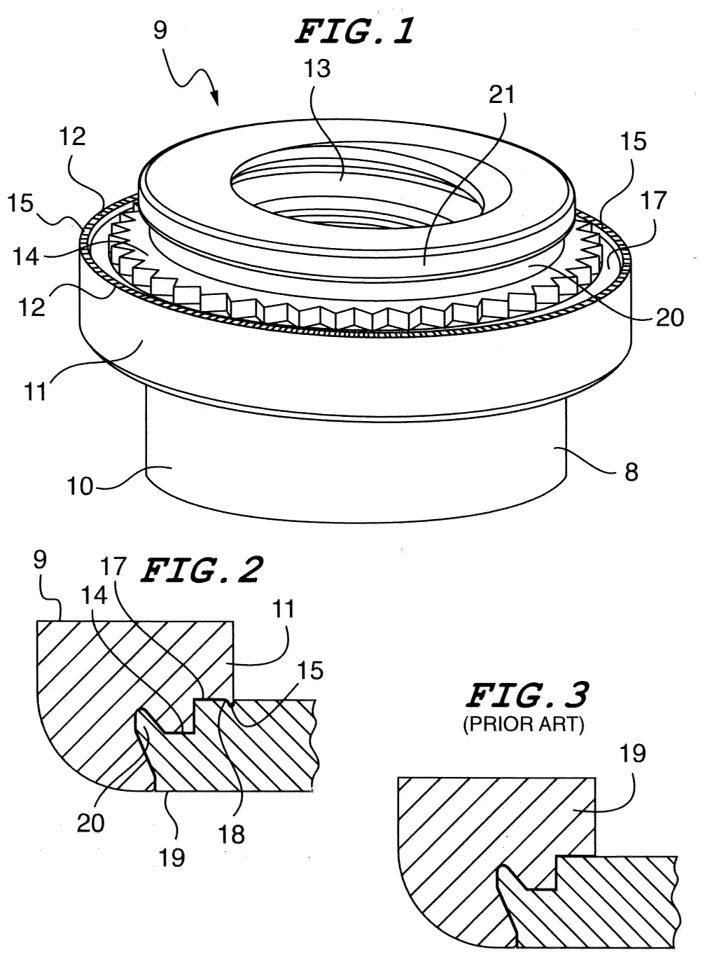

Referring now to FIG. 1, one embodiment of the invention 9 has novel material displacing features. This is a bottom view, that is, as seen from the receiving panel. As described herein, the new displacer features include an additional peripheral rim 15 which axially displaces material of the attached panel along the perimeter of the fastener. This location will cause material deformation at the farthest point of first contact between the fastener and panel. Typically, clinch fasteners are received within a preformed hole in a receiving panel of metal.

As seen in FIG. 1, a nut embodiment of the invention has a main body 10 with a flange 11 and an internal axial threaded through-bore 13. A displacer ring 14 has radial teeth for enhanced torque resistance. Hemi-spherical indentations providing a dimpled serration 12 are added to the distal edge of peripheral displacer rim 15 to produce an uneven pattern of panel material. This accommodates different compositions and microstructures within the panel material and ease the transition of material flow in the cold flow state. The dimpled edge 12 creates stress concentration points on the receiving panel when been installed. This allows for the surface material to be broken up which would traditionally be surface hardened or have oxides on them where the material below would be in a more malleable state. This dimpled feature will allow this more material to be contacted quicker and hence prioritize its movement.

With continued reference to FIG. 1, The bottom end is defined by a bead 21. Immediately above the bead is undercut 20 formed between the bead 21 and displacer ring 14. An inner bottom surface 17 of the flange 11 extends radially between the ring 14 and rim 15. A shank 8 extends axially from the flange 11 to the top end of the fastener body.

FIG. 2 is a partial sectional view of the clinch nut of FIG. 1, top side up, as installed into a receiving panel with the leak path defined by the joint seam between the fastener and the receiving panel now highlighted. The leak path is the path a fluid must take to flow from one side of an attached panel to the opposite side. When assembled to a panel 19, the bottom inner surface portion 17 of the flange 11 bottoms out against the panel 19 and thereby determines the depth of fastener insertion into the panel. Just inside the displacer ring 14 is an undercut 20 also seen in FIG. 1. With this construction, a trough is formed between the displacer ring 14 and the peripheral rim 15 that extends downward from the outer wall of the fastener. The inner bottom surface of the flange 17 which forms a planar base of a trough contributes greatly to the increased length of the seam between the fastener and the panel which defines an elongated the leak path. In this embodiment the trough is in the shape of a cylindrical groove which extends radially from the displacer ring 14 to the inner wall 18 of the peripheral rim 15. The inner wall 18 of the peripheral rim 15 generally defines a plain cylinder or a truncated cone in the case of this circular clinch nut. Both the trough and the rim inner wall 18 have plain featureless surfaces so that the cold flow of panel material is not being interrupted by any irregular features that could adversely affect the integrity of the joint sealing. This further prevents panel material voids in undesired locations. These features including the peripheral rim 15 greatly increases the length of leak path seam between the joined parts and hence the desired elongation of the leak path of the prior art as seen in FIG. 3.

FIG. 3 is a sectional view of a prior art clinch nut with the potential leak path highlighted in bold. When installed into the panel 19, the leak path indicates the route a substance would have to flow along to migrate to the opposite side of the panel.

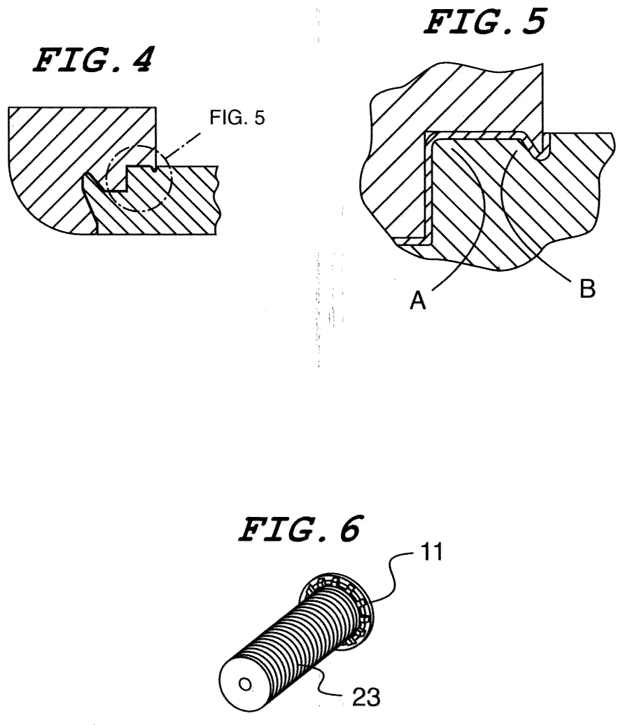

FIGS. 4 and 5 are sectional views of the novel clinch features with specific areas of the intersection between the fastener and the panel called out. The material displacers can produce areas of encapsulated compressed air. This attribute further prevents liquid from seeping under the head of the fastener by capillary action which can lead to the accelerated wear on the joint and potential creation of new leak paths. The encapsulated air, confined to its respective locations identified at corner areas A and B as seen in enlarged view FIG. 5 is formed during the installation process and will be pressurized to above atmospheric pressure. This creates an additional barrier for liquid ingress to overcome. This trapped air also decreases the probability of voids being present in undesired locations.

Therefore, not only has the applicant devised a novel leak-proof structure for a clinch fastener, but also a new method of assembly has been devised. With the clinch fastener depicted in the embodiments of the invention and as shown in FIG. 5, pressurized air pockets A and B in the joint between the fastener and the receiving panel can be created. This is done by increasing the speed of pressing the fastener into the panel. Formation of these pressurized air pockets contribute greatly to the leak-resistant performance of the invention. A rapid press-in installation ensures that air will be trapped without time to escape before installation has been completed. Achieving sufficient high speed will be determined by the customary amount of trial and error and will depend on panel material as well as other factors.

In FIG. 6 an alternate embodiment of the invention with the above-described clinch features applied here to a clinch stud. Here, the shank 23 extending downward from the inner flange portion is externally threaded to attach objects at the opposite side of a receiving panel. Alternatively, the stud can equally extend upwardly from the top of the flange 11.

Although the present invention is described through embodiments, those of ordinary skill in the art know that the present invention has many variations and changes without departing from the spirit of the present invention. It is intended that the appended embodiments include these variations and changes without departing from the present invention. The scope of the invention is defined solely by the following claims and their legal equivalents.

What is claimed is:

1. A clinch fastener, Comprising:
a body having top and bottom ends with a cylindrical shank at the top;
a displacer bead defining the bottom end of the fastener;
a radial undercut located immediately above the displacer bead;
a displacer ring located immediately above the undercut and extending radially from the undercut;
a flange located immediately above the displacer ring having a planar inner portion extending from the top of the ring;
a peripheral rim being the greatest diameter of the fastener and extending downward from said inner portion of the flange to a distal edge;
a shank extending upwardly from the flange having a distal end defining the top end of the fastener; and
wherein the rim has a circular edge adapted and constructed to penetrate and displace material of a receiving panel into which the fastener is pressed.

2. The clinch fastener of claim 1 wherein the edge of said rim is dimpled, having a series of hemi-spherical indentations.

3. The clinch fastener of claim 1 wherein a first concave corner is located at a junction of the displacer ring and the inner flange and wherein a second concave corner is located at a junction of the inner portion of the flange and the rim.

4. The clinch fastener of claim 1 wherein the panel is composed of metal.

5. The clinch fastener of claim 1 wherein the body has an internally threaded through-bore.

6. The clinch fastener of claim 1 wherein the shank is externally threaded.

7. A method of affixing the fastener of claim 3 to a receiving panel of metal by rapidly pressing the fastener into the panel with sufficient speed such that compressed pockets of air above atmospheric pressure are trapped and encapsulated at least at one of the first and second concave corners.

8. The method of claim 7 wherein the body have an internally threaded through-bore.

9. The method of claim 7 wherein the shank is externally threaded.

10. The method of claim 7 wherein the fastener is pressed into a preformed hole in the receiving panel.
